(19) United States
(12) Patent Application Publication
(10) Pub. No.: US 2019/0222071 A1
(43) Pub. Date: Jul. 18, 2019

(54) WIRELESS POWER TRANSMISSION SYSTEM

(71) Applicant: I-SHOU UNIVERSITY, Kaohsiung City (TW)

(72) Inventors: Chung-Long Pan, Kaohsiung City (TW); Rong-Ching Wu, Kaohsiung City (TW); Wei-Cheng Lin, Kaohsiung City (TW); You-Hua Jiang, Kaohsiung City (TW)

(21) Appl. No.: 16/039,240

(22) Filed: Jul. 18, 2018

(30) Foreign Application Priority Data
Jan. 18, 2018 (TW) 107101844

(51) Int. Cl. H02J 50/23; H02J 50/27; H01Q 19/30

(52) U.S. Cl. CPC H02J 50/23; H01Q 19/30; H02J 50/27

(57) ABSTRACT

A wireless power transmission system is provided. The wireless power transmission system includes a transmitting antenna and a receiving antenna. The transmitting antenna is coupled to a power source device, and the transmitting antenna is a Yagi-Uda antenna. The transmitting antenna receives a first power signal provided by the power source device and transmits a power radiation signal toward a first direction. The receiving antenna is coupled to a rectifier, the rectifier is coupled to a power receiver, and the receiving antenna is a Yagi-Uda antenna. The receiving antenna has a predetermined distance from the transmitting antenna. The receiving antenna receives the power radiation signal and converts the power radiation signal into a second power signal. The rectifier converts the second power signal into a third power signal and transmits the third power signal to the power receiver.

### CROSS-REFERENCE TO RELATED APPLICATION

THIS APPLICATION CLAIMS THE PRIORITY BENEFIT OF TAIWAN APPLICATION (TW107101844 FILED ON Jan. 18, 2018). THE ENTIRETY OF THE ABOVE-MENTIONED PATENT APPLICATION IS HEREBY INCORPORATED BY REFERENCE HEREIN AND MADE A PART OF THIS SPECIFICATION.

### FIELD OF THE INVENTION

The invention relates to a transmission system, and more particularly to a wireless power transmission system using the Yagi-Uda antenna.

### BACKGROUND OF THE INVENTION

With the popularity of various types of electronic products, people are increasingly relying on electronic products, and more and more portable electronic devices such as smart phones or tablet computers are also being developed. With the popularization of these electronic devices, the demand for charging is also constantly increasing. The user wants to be able to minimize the frequency of carrying cables, therefore the wireless charging technology becomes a new method to overcome this issue.

When wireless charging technology is applied to the electronic device, the power is transmitted by the transmitting antenna or the transmitting coil and then received by the receiving antenna or the receiving coil. However, the use of transmitting coil and receiving coil to transmit power must be within a short distance which will result to significant limitations. The efficiency of transmitting power using a transmitting antenna and a receiving antenna is very low, and the cost is high in nowadays. Therefore, how to build up a high-efficiency and low-cost wireless power transmission system is the focus of relevant personnel in this field.

### SUMMARY OF THE INVENTION

An objective of the invention is to provide a wireless power transmission system by using the Yagi-Uda antenna for power transmission.

Other objectives and advantages of the invention may be further illustrated by the technical features disclosed in the invention.

In order to achieve one or a portion of or all of the objectives or other objectives, an embodiment of the invention provides a wireless power transmission system including a transmitting antenna and a receiving antenna. The transmitting antenna is coupled to a power source device, the transmitting antenna is a Yagi-Uda antenna, and the transmitting antenna receives a first power signal provided by the power source device and transmits a power radiation signal toward a first direction. The receiving antenna is coupled to a rectifier, the rectifier is coupled to a power receiver, the receiving antenna is a Yagi-Uda antenna, the distance between the transmitting antenna and the receiving antenna is a predetermined distance, the receiving antenna receives the power radiation signal and converts the power radiation signal into a second power signal, and the rectifier converts the second power signal into a third power signal and transmits the third power signal to the power receiver.

In one embodiment of the invention, the transmitting antenna includes a first substrate, a first reflector, a first actuator and a plurality of first directors, the first reflector, the first actuator and the first directors are sequentially disposed on the first substrate along the first direction, the first actuator is configured to receive the first power signal and generate a first radiation field, and the first directors are configured to pull the first radiation field toward the first direction, so that the transmitting antenna transmits the power radiation signal toward the first direction.

In one embodiment of the invention, the transmitting antenna is a printed Yagi-Uda antenna, the first reflector, the first actuator and the first directors are metal layers printed on the first substrate.

In one embodiment of the invention, the number of the first directors is seven, and the spacing of the first actuator and the first directors is a first predetermined spacing distance.

In one embodiment of the invention, the receiving antenna includes a second substrate, a second reflector, a second actuator and a plurality of second directors, the second reflector, the second actuator and the second directors are sequentially disposed on the second substrate along a second direction, wherein the second direction is opposite to the first direction, and the second directors are configured to receive the power radiation signal and pull the power radiation signal toward the first direction and generate a second radiation field, and the second actuator is configured to receive the second radiation field and generate the second power signal.

In one embodiment of the invention, the receiving antenna is a printed Yagi-Uda antenna, the second reflector, the second actuator and the second directors are metal layers printed on the second substrate.

7. The wireless power transmission system according to claim 5, wherein the number of the second directors is seven, and the spacing of the second actuator and the second directors is a second predetermined spacing distance.

In one embodiment of the invention, the transmitting antenna includes a first substrate, a first reflector, a first actuator and a plurality of first directors, the first reflector, the first actuator, and the first directors are sequentially disposed on a first surface of the first substrate along the first direction, the first actuator is configured to receive the first power signal and generate a first radiation field, the first directors are configured to pull the first radiation field toward the first direction, so that the transmitting antenna transmits the power radiation signal toward the first direction, the receiving antenna includes a second substrate, a second reflector, a second actuator and a plurality of second directors, the second reflector, the second actuator and the second directors are sequentially disposed on a second surface of the second substrate along a second direction, wherein the second direction is opposite to the first direction, the second substrate is parallel to the first substrate, the first surface and the second surface are in the same plane, the first reflector, the first actuator, the first directors, the second directors, the second actuator and the second reflector are arranged in a straight line, the second directors are configured to receive the power radiation signal and pull the power radiation signal toward the first direction and generate a second radiation field, and the second actuator is configured to receive the second radiation field and generate the second power signal.

In one embodiment of the invention, the rectifier includes a three stage voltage multiplier circuit, and the voltage of the third power signal is six times the voltage of the second power signal.

In one embodiment of the invention, the rectifier includes a metal-semiconductor junction diode for converting the second power signal into the third power Signal.

In one embodiment of the invention, the frequency of the power radiation signal is between 2.3 GHz and 2.5 GHz.

In one embodiment of the invention, the predetermined distance between the transmitting antenna and the receiving antenna is from 30 cm to 100 cm.

The wireless power transmission system of the present invention using two Yagi-Uda antennas as being the power transmitting antenna and the power receiving antenna to let the wireless power transmission system transmits wireless power by Yagi-Uda antennas.

Other objectives, features and advantages of The invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a wireless power transmission system according to an embodiment of the present invention.

FIG. 2 is a block diagram of a wireless power transmission system according to an embodiment of the present invention.

FIG. 3A is a schematic diagram of the transmitting antenna of a wireless power transmission system according to an embodiment of the present invention.

FIG. 3B is a schematic diagram of the receiving antenna of a wireless power transmission system according to an embodiment of the present invention.

FIG. 4A is a schematic diagram of the reflection loss of a wireless power transmission system according to an embodiment of the present invention.

FIG. 4B is the Smith chart of a wireless power transmission system according to an embodiment of the present invention.

FIG. 5 is a block diagram of a wireless power transmission system according to another embodiment of the present invention.

FIG. 6A is a schematic diagram of the reflection loss of a wireless power transmission system according to another embodiment of the present invention.

FIG. 6B is the Smith chart of a wireless power transmission system according to another embodiment of the present invention.

### DETAILED DESCRIPTION OF PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

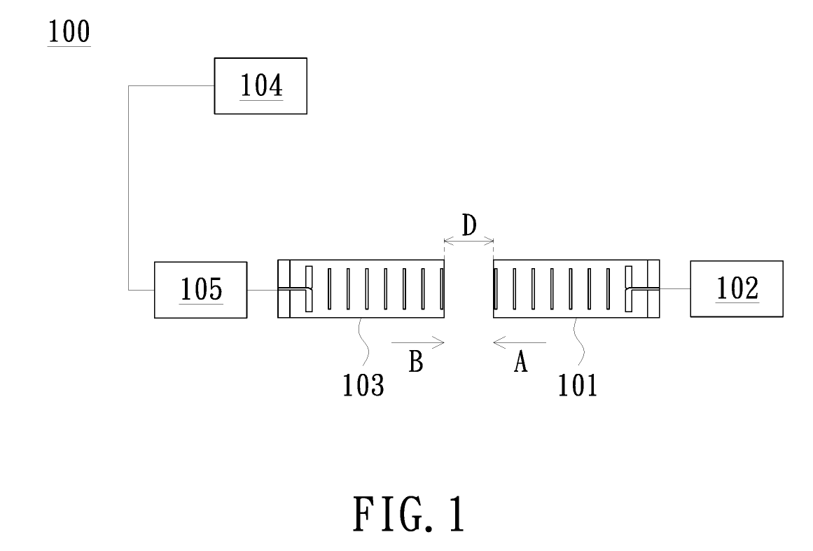

Referring to FIG. 1. FIG. 1 is a schematic diagram of a wireless power transmission system according to an embodiment of the present invention. The wireless power transmission system 100 includes a transmitting antenna 101, a power source device 102, a receiving antenna 103, a rectifier 105, and a power receiver 104. Both the transmitting antenna 101 and the receiving antenna 103 are Yagi-Uda antennas. The transmitting antenna 101 receives a power signal provided by the power source device 102 and transmits a power radiation signal toward a first direction A. The distance between the receiving antenna 103 and transmitting antenna 101 is a predetermined distance D. The receiving antenna 103 receives the power radiation signal transmitted by the transmitting antenna 101, converts the power radiation signal into a power signal, and transmits the power signal to the rectifier 105. The rectifier 105 converts the power signal received and transmits it to the power receiver 104. In this way, the wireless power transmission system 100 of the embodiment uses two Yagi-Uda antennas as the power transmitting antenna and the power receiving antenna, respectively, so that the wireless power transmission system 100 can wirelessly transmit the power by the Yagi-Uda antennas. The details of the operation will be described in detail below.

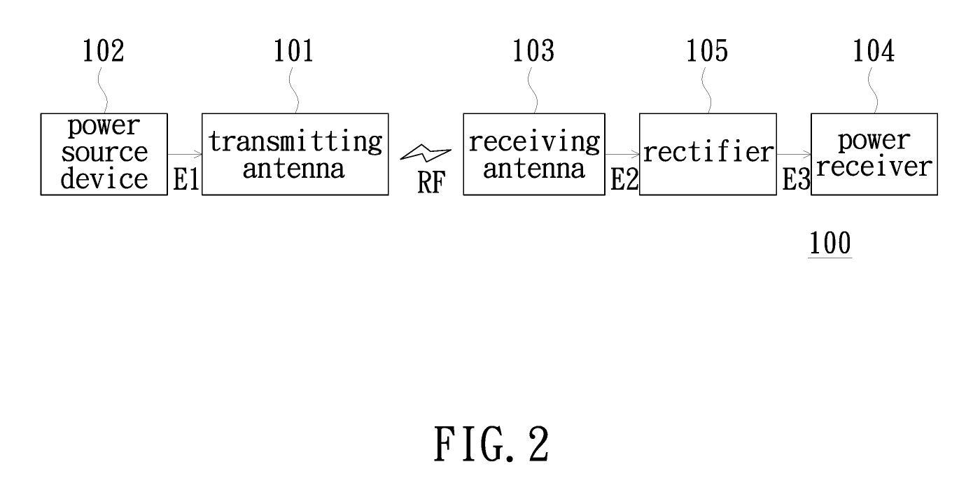

Referring to FIG. 2. FIG. 2 is a block diagram of the wireless power transmission system 100 shown in FIG. 1. The wireless power transmission system 100 includes a transmitting antenna 101, a power source device 102, a receiving antenna 103, a rectifier 105, and a power receiver 104. The transmitting antenna 101 is coupled to the power source device 102, and the transmitting antenna 101 is a Yagi-Uda antenna. The transmitting antenna 101 receives a first power signal E1 provided by the power source device 102 and transmits a power radiation signal RF toward a first direction A. The receiving antenna 103 is coupled to the rectifier 105, and the rectifier 105 is coupled to the power receiver 104. The receiving antenna 103 is a Yagi-Uda antenna and the distance between the receiving antenna 103 and transmitting antenna 101 is a predetermined distance D. The receiving antenna 103 receives the power radiation signal RF transmitted by the transmitting antenna 101 and converts the power radiation signal RF into a second power signal E2. The receiving antenna 103 transmits the second power signal E2 to the rectifier 105. The rectifier 105 converts the second power signal E2 into a third power signal E3 and transmits the third power signal E3 to the power receiver 104 so as to achieve the purpose of wirelessly transmitting power using Yagi-Uda antennas.

The power source device 102, for example, can be implemented by using a signal generator and the power receiver 104 can be implemented by using an RF network analyzer, to which the present invention is not limited. The power source device 102 only needs to be a power source device that can provide the first power signal E1, and the power receiver 104 only needs to be a device that can receive the third power signal E3.

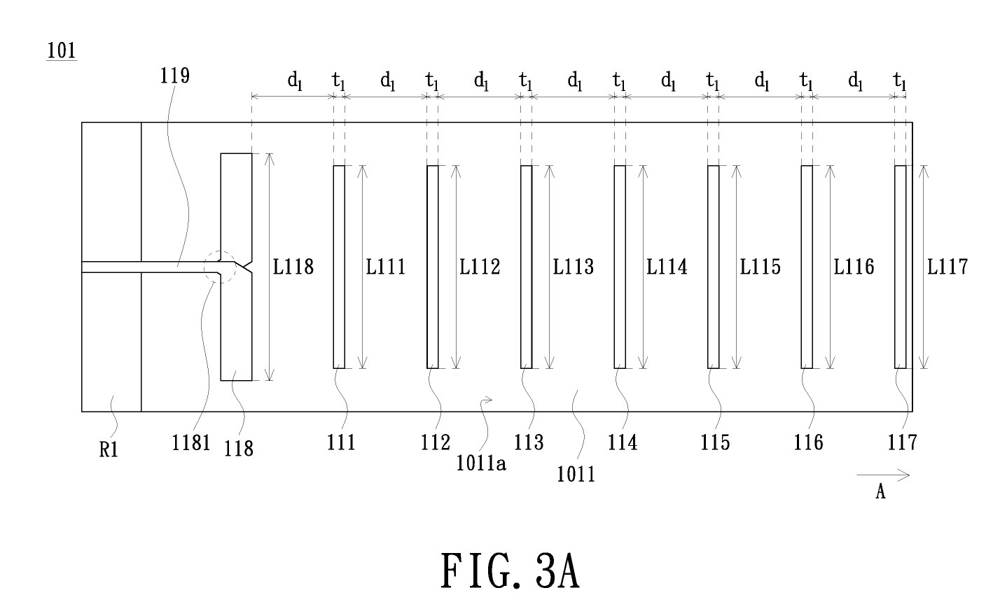

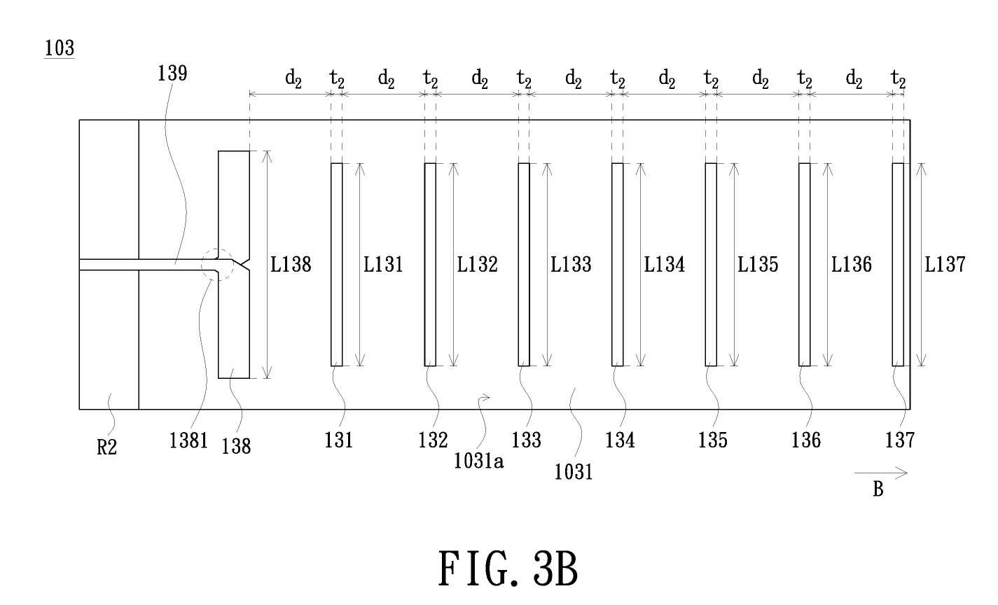

Referring to FIG. 3A. FIG. 3A is a schematic diagram of the transmitting antenna 101 of the wireless power transmission system 100 shown in FIG. 1. Specifically, the transmitting antenna 101 includes a first substrate 1011, a first reflector R1, a first actuator 118, and first directors 111, 112, 113, 114, 115, 116, and 117. The first reflector R1, the first actuator 118, and the first directors 111, 112, 113, 114, 115, 116, and 117 are sequentially disposed on the first surface 1011a of the first substrate 1011 along the first direction A. The first actuator 118 is configured to receive the first power signal E1 provided by the power source device 102 and generate a first radiation field (not shown in the figures), and the first directors 111, 112, 113, 114, 115, 116 and 117 are configured to pull the first radiation field toward the first direction A, so that the transmitting antenna 101 transmits the power radiation signal RF toward the first direction A. The first reflector R1 has the function of reflecting the first radiation field toward the first direction A and also has the function of shielding the radiation from the left side in FIG. 3A.

Referring to FIG. 3B. FIG. 3B is a schematic diagram of the receiving antenna 103 of the wireless power transmission system 100 shown in FIG. 1. Specifically, the receiving antenna 103 includes a second substrate 1031, a second reflector R2, a second actuator 138, and second directors 131, 132, 133, 134, 135, 136, and 137. The second reflector R2, the second actuator 138 and the second directors 131, 132, 133, 134, 135, 136, and 137 are sequentially disposed on the second surface 1031a of the second substrate 1031 along a second direction B, wherein the second direction B is opposite to the first direction A. The second directors 131, 132, 133, 134, 135, 136, and 137 are configured to receive the power radiation signal RF transmitted by the transmitting antenna 101 and pull the power radiation signal RF toward the first direction A to form a second radiation field (not shown in the figures). The second actuator 138 is configured to receive the second radiation field and generate the second power signal E2. The second reflector R2 has the function of shielding the radiation from the left side in FIG. 3B and also has the function of reflecting the second radiation field to the second direction B.

Specifically, the second substrate 1031 of the receiving antenna 103 is parallel to the first substrate 1011 of the transmitting antenna 101, the first surface 1011a and the second surface 1031a are in the same plane, and the first reflector R1, the first actuator 118, the first directors 111, 112, 113, 114, 115, 116, 117, the second directors 131, 132, 133, 134, 135, 136, 137, the second actuator 138 and the second reflector R2 are arranged in a straight line in this embodiment.

In detail, the first actuator 118 of the transmitting antenna 101 may have a first feed end 1181 and connect to the first transmission line 119 through the first feed end 1181, and the first transmission line 119 is configured to connect the power source device 102. The first actuator 118 could receive the first power signal E1 transmitted from the first transmission line 119 through the first feed end 1181. The second actuator 138 of the receiving antenna 103 may have a second feed end 1381 and connect to the second transmission line 139 through the second feed end 1381. After generating the second power signal E2, the second actuator 138 could transmit the second power signal E2 to the second transmission line 139 through the second feed end 1381, and the second transmission line 139 could transmit the second power signal E2 to the rectifier 105. The configurations of the first feed end 1181, the first transmission line 119, the second feed end 1381 and the second transmission line 139 shown in FIG. 3A and FIG. 3B are merely examples, to which the present invention is not limited.

In addition, the transmitting antenna 101 could be a printed Yagi-Uda antenna, and the first reflector R1, the first actuator 118 and the first directors 111, 112, 113, 114, 115, 116 and 117 are metal layers printed on the first substrate 1011. In addition, the first transmission line 119 could be a metal layer printed on the first substrate 1011. The receiving antenna 103 could be a printed Yagi-Uda antenna, and the second reflector R2, the second actuator 138 and the second directors 131, 132, 133, 134, 135, 136 and 137 are metal layers printed on the second substrate 1031. In addition, the second transmission line 139 could be a metal layer printed on the second substrate 1031. The first substrate 1011 and the second substrate 1031 could include the insulation material.

In this embodiment, the transmitting antenna 101 includes seven first directors 111, 112, 113, 114, 115, 116 and 117 as an example, and the spacing of the first actuator 118, the first directors 111, 112, 113, 114, 115, 116 and 117 is a first predetermined spacing distance dl. In this embodiment, the receiving antenna 103 includes seven second directors 131, 132, 133, 134, 135, 136, and 137 as an example, and the spacing of the second actuator 138, the second directors 131, 132, 133, 134, 135, 136, and 137 is a second predetermined spacing distance d2. Experiments have shown that the transmitting antenna 101 has seven first directors 111, 112, 113, 114, 115, 116, 117 and the receiving antenna 103 has seven second directors 131, 132, 133, 134, 135, 136, 137, the wireless power transmission system 100 has a better power conversion efficiency.

In this embodiment, experiments have shown that the first predetermined spacing distance dl between the first actuator 118, the first directors 111, 112, 113, 114, 115, 116, and 117 is 18.3 mm, and the second predetermined spacing distance d2 between the second actuator 138, the second directors 131, 132, 133, 134, 135, 136, and 137 is 18.3 mm, the wireless power transmission system 100 could have a better power conversion efficiency. While in this present embodiment, the width t1 of the first directors 111, 112, 113, 114, 115, 116 and 117 is 1.9 mm, the width t2 of the second directors 131, 132, 133, 134, 135, 136 and 137 is 1.9 mm, the lengths of the first directors 111, 112, 113, 114, 115, 116 and 117 are L111=43.5 mm, L112=39 mm, L113=36 mm, L114=36 mm, L115=36 mm, L116=36 mm and L117=36 mm, the lengths of the second directors 131, 132, 133, 134, 135, 136 and 137 are L131=43.5 mm, L132=39 mm, L133=36 mm, L134=36 mm, L135=36 mm, L136=36 mm and L137=36 mm, the length L118 of the first actuator 118 is 48.9 mm, and the length L138 of the second actuator 138 is 48.9 mm, the wireless power transmission system 100 could have the better power conversion efficiency. The foregoing numerical values are only examples of preferable results of this embodiment, to which the present invention is not limited. The specific experimental results will be described in detail below.

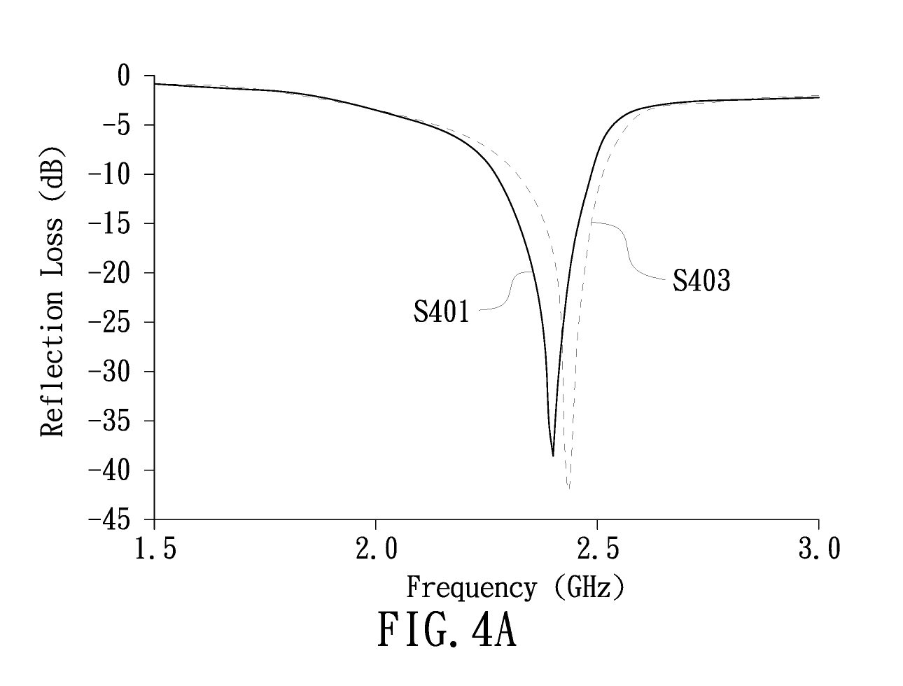

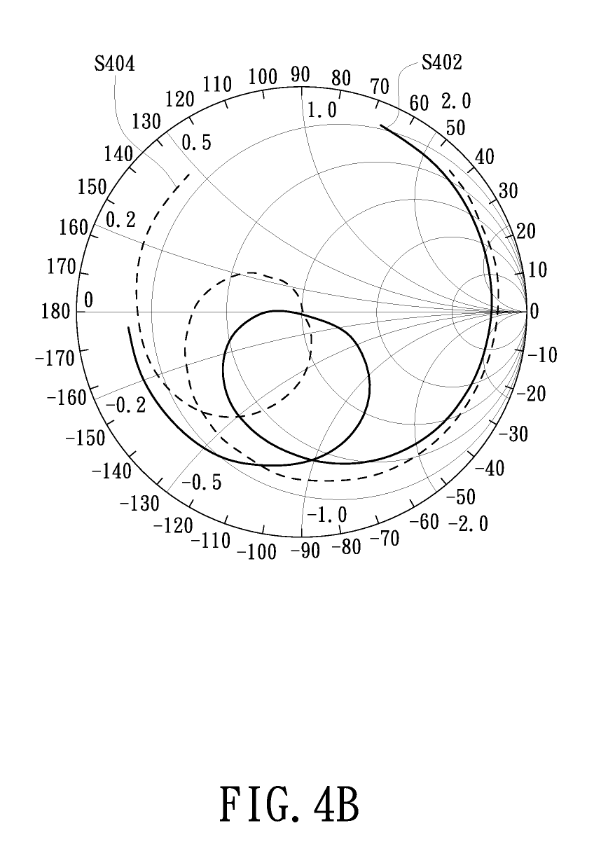

Referring to FIG. 4A and FIG. 4B, FIG. 4A is a schematic diagram of the reflection loss of the wireless power transmission system 100 according to the embodiment of the present invention, and FIG. 4B is the Smith chart of the wireless power transmission system 100 according to the embodiment of the present invention. In FIG. 4A, the curve S401 is the simulated value of software simulation, and the curve S403 is the experimental value experimentally measured. When the wireless power transmission system 100 operates at the frequency of 2.45 GHz in the embodiment of the present invention, the experimental reflection loss is about −42 dB, and the simulated reflection loss is about −38 dB. In FIG. 4B, the curve S402 is the simulated value of software simulation, and the curve S404 is the experimental value experimentally measured.

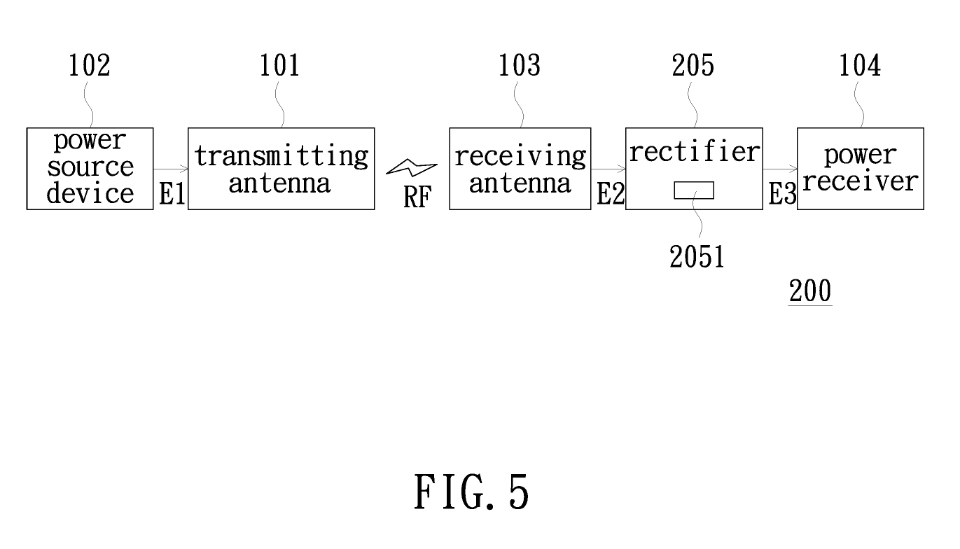

Referring to FIG. 5. FIG. 5 is a block diagram of a wireless power transmission system 200 according to another embodiment of the present invention. The wireless power transmission system 200 of this embodiment has the similar structure and function to the wireless power transmission system 100 shown in FIG. 1-FIG 3B. The difference between this embodiment and the embodiment shown in FIG. 1-FIG 3B is that the rectifier 205 includes a three stage voltage multiplier circuit 2051. The three stage voltage multiplier circuit 2051 can make the voltage of the third power signal E3 output by the rectifier 205 being six times higher than the voltage of the second power signal E2, and the input impedance of the rectifier 205 can be matched with the impedance of the receiving antenna 103, so as to achieve better power conversion efficiency. The rectifier 205, for example, could include a metal-semiconductor junction diode for converting the second power signal E2 into the third power signal E3. Compared to the semiconductor-semiconductor junction diode, the metal-semiconductor junction diode used in this embodiment has a fast switching time, so that the wireless power transmission system 200 can perform wireless power transmission at a high frequency. In this embodiment, the frequency of the power radiation signal RF is 2.45 GHz, to which the present invention is not limited. In other embodiments of the present invention, the frequency of the power radiation signal RF could be, for example, between 2.3 G Hz and 2.5 GHz, to which the present invention is not limited.

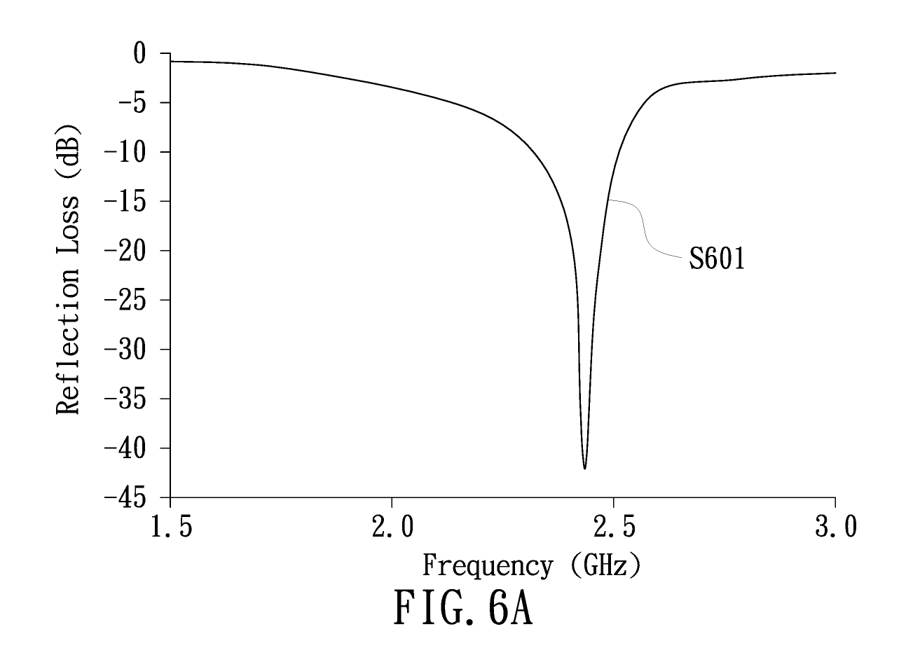

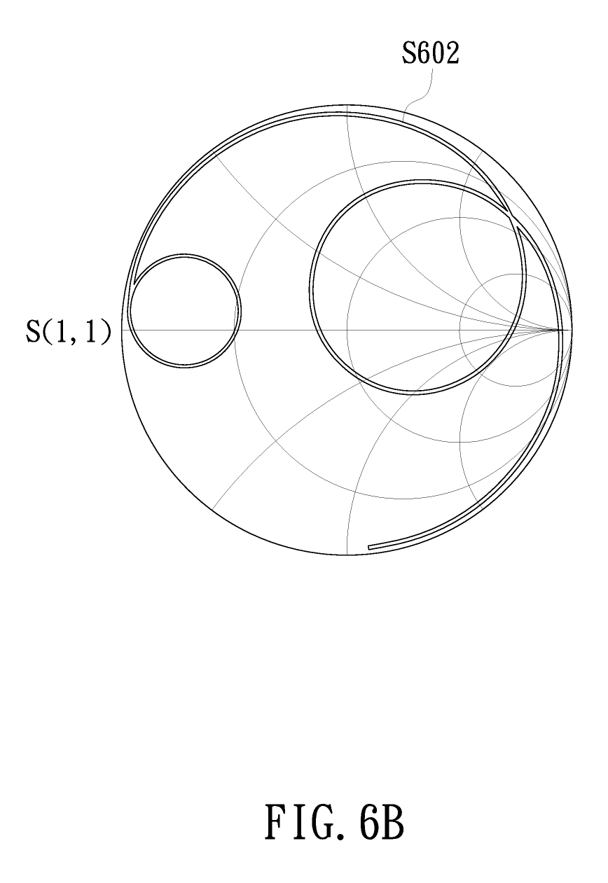

Referring to FIG. 6A and FIG. 6B, FIG. 6A is a schematic diagram of the reflection loss of the wireless power transmission system 200 shown in FIG. 5. FIG. 6B is the Smith chart of the wireless power transmission system 200 shown in FIG. 5. In FIG. 6A, curve S601 is an experimentally measured experimental value. When the wireless power transmission system 200 of this embodiment operates at the frequency of 2.45 GHz, the experimental reflection loss is about −19 dB. In FIG. 6B, curve S602 is an experimentally measured experimental value.

Referring to Table 1, Table 1 shows the relationship between the output voltage generated by the wireless power transmission system 200 shown in FIG. 5 and the distance between the antennas. Table 1 shows that when the wireless power transmission system 200 operates at the frequency of 2.45 GHz, the predetermined distance D between the receiving antenna 103 and the transmitting antenna 101 is set at 30 cm to 100 cm, and the measured voltage of the third power signal E3 output from the rectifier 205. The rectifier 205 can output a DC voltage of 3.2V at D=30 cm and is equivalent to having 51% RF-DC conversion efficiency. However, this is only experimental data of an embodiment of the present invention, to which the present invention is not limited.

| D (cm) | Output DC voltage (V) |
|---|---|
| 30 | 3.2 |
| 40 | 2.4 |
| 50 | 2.2 |
| 60 | 1.8 |
| 70 | 1.6 |
| 80 | 1.1 |
| 90 | 0.8 |
| 100 | 0.56 |

In summary, the wireless power transmission system according to the embodiment of the present invention uses two Yagi-Uda antennas as the power transmitting antenna and the power receiving antenna, respectively, so that the wireless power transmission system can wirelessly transmit power by the Yagi-Uda antenna, not only with high efficiency but also having low cost. Also, compared to the wireless power transmission using the coil, the wireless power transmission system of the present invention can wirelessly transmit power over a long distance and has a high power conversion efficiency.

The descriptions illustrated supra set forth simply the exemplary embodiments of the present invention; however, the characteristics of the present invention are by no means restricted thereto. All changes, alterations, or modifications conveniently considered by those skilled in the art are deemed to be encompassed within the scope of the present invention delineated by the following claims.

What is claimed is:

1. A wireless power transmission system, comprising:
a transmitting antenna, coupled to a power source device, the transmitting antenna is a Yagi-Uda antenna, and the transmitting antenna receives a first power signal provided by the power source device and transmits a power radiation signal toward a first direction; and
a receiving antenna, coupled to a rectifier, the rectifier is coupled to a power receiver, the receiving antenna is a Yagi-Uda antenna, the distance between the transmitting antenna and the receiving antenna is a predetermined distance, the receiving antenna receives the power radiation signal and converts the power radiation signal into a second power signal, and the rectifier converts the second power signal into a third power signal and transmits the third power signal to the power receiver.

2. The wireless power transmission system according to claim 1, wherein the transmitting antenna comprises a first substrate, a first reflector, a first actuator and a plurality of first directors, the first reflector, the first actuator and the first directors are sequentially disposed on the first substrate along the first direction, the first actuator is configured to receive the first power signal and generate a first radiation field, and the first directors are configured to pull the first radiation field toward the first direction, so that the transmitting antenna transmits the power radiation signal toward the first direction.

3. The wireless power transmission system according to claim 2, wherein the transmitting antenna is a printed Yagi-Uda antenna, the first reflector, the first actuator and the first directors are metal layers printed on the first substrate.

4. The wireless power transmission system according to claim 2, wherein the number of the first directors is seven, and the spacing of the first actuator and the first directors is a first predetermined spacing distance.

5. The wireless power transmission system according to claim 1, wherein the receiving antenna comprises a second substrate, a second reflector, a second actuator and a plurality of second directors, the second reflector, the second actuator and the second directors are sequentially disposed on the second substrate along a second direction, wherein the second direction is opposite to the first direction, and the second directors are configured to receive the power radiation signal and pull the power radiation signal toward the first direction and generate a second radiation field, and the second actuator is configured to receive the second radiation field and generate the second power signal.

6. The wireless power transmission system according to claim 5, wherein the receiving antenna is a printed Yagi-Uda antenna, the second reflector, the second actuator and the second directors are metal layers printed on the second substrate.

7. The wireless power transmission system according to claim 5, wherein the number of the second directors is seven, and the spacing of the second actuator and the second directors is a second predetermined spacing distance.

8. The wireless power transmission system according to claim 1, wherein the transmitting antenna comprises a first substrate, a first reflector, a first actuator and a plurality of first directors, the first reflector, the first actuator, and the first directors are sequentially disposed on a first surface of the first substrate along the first direction, the first actuator is configured to receive the first power signal and generate a first radiation field, the first directors are configured to pull the first radiation field toward the first direction, so that the transmitting antenna transmits the power radiation signal toward the first direction, the receiving antenna comprises a second substrate, a second reflector, a second actuator and a plurality of second directors, the second reflector, the second actuator and the second directors are sequentially disposed on a second surface of the second substrate along a second direction, wherein the second direction is opposite to the first direction, the second substrate is parallel to the first substrate, the first surface and the second surface are in the same plane, the first reflector, the first actuator, the first directors, the second directors, the second actuator and the second reflector are arranged in a straight line, the second directors are configured to receive the power radiation signal and pull the power radiation signal toward the first direction and generate a second radiation field, and the second actuator is configured to receive the second radiation field and generate the second power signal.

9. The wireless power transmission system according to claim 1, wherein the rectifier comprises a three stage voltage multiplier circuit, and the voltage of the third power signal is six times the voltage of the second power signal.

10. The wireless power transmission system according to claim 9, wherein the rectifier comprises a metal-semiconductor junction diode for converting the second power signal into the third power Signal.

11. The wireless power transmission system according to claim 1, wherein the frequency of the power radiation signal is between 2.3 GHz and 2.5 GHz.

12. The wireless power transmission system according to claim 1, wherein the predetermined distance between the transmitting antenna and the receiving antenna is from 30 cm to 100 cm.
